(19) United States
(12) Patent Application Publication
(10) Pub. No.: US 2016/0240177 A1
(43) Pub. Date: Aug. 18, 2016

(54) Adjustable carrier for musical instrument cases, utilizing a method for securing cases which have handles

(71) Applicants: Brianna Marie Meisser, Weare, NH (US); Veronica Marie Meisser, Weare, NH (US); Brian Scott Meisser, Weare, NH (US)

(72) Inventors: Brianna Marie Meisser, Weare, NH (US); Veronica Marie Meisser, Weare, NH (US); Brian Scott Meisser, Weare, NH (US)

(21) Appl. No.: 15/017,672

(22) Filed: Feb. 7, 2016

Related U.S. Application Data
(60) Provisional application No. 62/113,304, filed on Feb. 6, 2015.

(51) Int. Cl. G10G 7/00

(52) U.S. Cl. CPC G10G 7/005

(57) ABSTRACT

We have invented a carrying device to transport musical instrument cases or other cases which have handles, utilizing a method for securing cases which have handles. The carrier folds around the case, and straps are threaded through the handle of the case and secured, to keep the case in place. The carrier has backpack-style straps, as well as a removable shoulder strap, and can support and carry a wide variety of size and style instrument or other cases which have handles.

### CROSS-REFERENCE TO RELATED APPLICATIONS

This application claims the benefit of PPA Number 62113304, filed Feb. 6, 2015 by the present inventors, which is incorporated by reference. Note: This application contains changes that were not included in the original provisional patent application.

### BACKGROUND

### Description of the Prior Art

Any musician, amateur or professional, must regularly transport his or her instrument through a variety of conditions and obstacles. Such travel with instruments often includes various methods of transportation and distances. Musical instruments are usually delicate and often valuable, therefore requiring rigid, heavy cases to protect them while being transported. While such cases protect the instrument, they often impede travel on foot, through crowds, or for any substantial distance. Such cases are also difficult to maneuver in confined spaces. A heavy, protective case can cause strain and can tire the person carrying it when clutched in the hand for long periods of time. This is particularly problematic, since most musicians delicately employ their hands and arms in order to play their instruments.

In addition, musicians must also carry sheet music and other accessories such as music stands and instrument stands, which do not always fit into their instrument case. Music students also sometimes need their hands free to carry books and notebooks for other school classes.

One common solution is to use what is often referred to as a “gig bag,” which is a light-weight, soft, pliable case. Such soft cases have many inherent disadvantages. They offer an instrument little protection from bumps and can be easily knocked over or crushed. If an instrument in a soft case falls off the wearer, falls over while standing, or the wearer falls or stumbles, the instrument can easily be damaged. Such soft cases are designed and manufactured specifically to fit a certain style and type of instrument. An owner of multiple instruments must have a different soft case customized for each instrument. This considerable expense is usually in addition to the expense of a regular protective case yet compromises the instrument's protection in exchange for ease of transport. Also a soft case cannot be used to transport a musical instrument when travel circumstances necessitate that the instrument be stacked in a cargo hold or checked on public transportation. In such circumstance, a soft case would not offer the contained instrument the necessary protection to ensure its safe, undamaged transport. In addition, students who are renting an instrument are given a hard case, which cannot be modified. Also, new students may decide to switch instruments. They would need a new soft case for each instrument change.

The bag for musical instruments (Wilfer, U.S. Pat. No. 6,505,762) relies upon a zipper to secure the instrument case, which creates an inherent point of weakness in the design because the weight of the instrument is being supported by only the strength of the zipper. Also, because the bag for musical instruments (U.S. Pat. No. 6,505,762) claims to have the shape of the musical instrument case, it does not lend itself to fit a variety of musical instrument cases, but must be custom tailored to each particular case for a proper fit.

The multi-function backpack for musical instrument cases (Lucey, U.S. Pat. No. 8,292,138) secures instruments by means of bottom panels and two transverse straps that attach above the contours of the body of the case where the case's shape corresponds to the spot where the neck of the instrument meets the body of the instrument. It does not lend itself well to instrument cases that are rectangular and do not have a neck. In addition, the multi-function backpack for musical instrument cases (Lucey, U.S. Pat. No. 8,292,138) does not have a removable shoulder strap. This is an important option for students, who must carry their school supplies, as well as their instrument. Students who already carry a backpack for school need to have an alternate method for carrying their instrument.

U.S. Pat. No. 5,918,785 (Irose) discloses a harness and shoulder strap assembly to securely enclose, support, and form a carrying device for musical instrument cases. The case-engaging harness and shoulder straps comprise a plurality of adjustable strap loops connected by various fastenings, adjusters, releasable buckles, joiners, and fixing methods. The harness and shoulder strap assembly can safely support and carry a wide variety of size, shape, and style instruments and instrument cases. However, it is a strap system that is meant to be used as a backpack. It does not have a removable shoulder strap. In addition, it does not include any fabric that could protect the instrument case or provide pockets for music or accessories.

A backpack strap system for carrying loads of various sizes and or shapes (Leep, U.S. Pat No. 6,889,882), uses a flexible rectangular fabric. Although it is primarily designed to carry oversized loads such as animal carcasses, firewood and injured people, it could possibly be used to carry a case with a handle. However, the strapping system is complex, as it is designed to be able to accommodate loads of many different shapes and sizes. The backpack strap system for carrying loads of various sizes and or shapes (Leep, U.S. Pat No. 6,889,882) is also designed to be very portable and easy to store when not in use. As a result, it does not include padding. Because many musical instrument or other cases with handles are rigid and heavy, padding is useful in protecting both the case and the person carrying the case. In addition, the backpack strap system for carrying loads of various sizes and or shapes (Leep, U.S. Pat No. 6,889,882) does not have the option of being used with a removable shoulder strap.

### PRIOR ART

U.S. Patent Documents

| | | |
|---|---|---|
| U.S. Pat. No. 5,918,785 | July, 1999 | Irose |
| U.S. Pat. No. 6,505,762 | July, 2001 | Wilfer |
| U.S. Pat. No. 6,889,882 | May, 2005 | Leep |
| U.S. Pat. No. 8,292,138 | October, 2012 | Lucey |

### SUMMARY OF THE INVENTION

Briefly stated, the adjustable carrier for musical instrument cases, utilizing a method for securing cases which have handles, includes rectangular padded fabric with a rigid top and bottom and a strap system that wraps around a musical instrument or other case with a handle, threads through the handle, and connects to itself. The fabric then folds over the case and connects to itself. In one embodiment of the invention, on the inside of the carrier, the fabric also includes an accordion-style pocket on one side and two or more pockets on the other side. The carrier has two backpack-style straps that can be tucked away under a flap when not in use. Near two of the four corners of the carrier, there is a D-ring. A removable, padded shoulder strap can be clipped to the rings. They can also be used to attach accessories.

### BRIEF DESCRIPTION OF THE DRAWINGS

FIG. 1 shows the inside view of the adjustable carrier for musical instrument cases, utilizing a method for securing cases which have handles.

FIG. 2 shows the outside view of the adjustable carrier for musical instrument cases, utilizing a method for securing cases which have handles.

FIG. 3 shows a case with handles and the method for securing said case.

FIG. 4 is a side view of the adjustable carrier for musical instrument cases, utilizing a method for securing cases which have handles. It demonstrates the operation of the adjustable carrier for musical instrument cases, utilizing a method for securing cases which have handles.

### LIST OF REFERENCE NUMERALS

10a Fabric, inside top section

10b Fabric, inside middle section

10c Fabric, inside bottom section

11a Fabric, outside top section

11b fabric, outside middle section

11c Fabric, outside bottom section

12a Longitudinal strap, top part

12b Longitudinal strap, bottom part

14a Longitudinal strap, top part

14b Longitudinal strap, bottom part

16 Top strap

18 Bottom strap

20 Top rigid edge

22 Bottom rigid edge

24 Flap

26a Hook and loop fabric

26b Hook and loop fabric

27a Hook and loop fabric

27b Hook and loop fabric

28 Backpack-style strap

30 Backpack-style strap

32 Flap

34 Flap

36a Hook and loop fabric

36b Hook and loop fabric

38a Hook and loop fabric

38b Hook and loop fabric

40 D-ring

42 D-ring

44 Handle

46 Removable shoulder strap

### DETAILED DESCRIPTION OF THE INVENTION

The adjustable carrier for musical instrument cases, utilizing a method for securing cases which have handles has many advantages over the prior art. It can be used with instruments of many different shapes and sizes. The user can use the same carrier for different musical instruments. In addition, the carrier has a removable shoulder strap that gives the user the option to wear it either as a backpack or over the shoulder. This is an important option for students, who must carry their school supplies, as well as their instrument. Students who carry a backpack for school can choose the option of wearing the adjustable carrier for musical instrument cases on their shoulders, and students who carry a messenger bag to school can wear the adjustable carrier for musical instrument cases on their backs. The padding on the carrier allows for some protection of both the case and the person carrying the case. It is also suggested that the adjustable carrier for musical instrument cases, utilizing a method for securing cases which have handles, can include pockets for accessories such as sheet music, marching lyres, music stands, and other accessories. Finally, the adjustable carrier for musical instrument cases, utilizing a method for securing cases which have handles is not limited to carrying musical instrument cases. The strap system allows the carrier to secure many cases of different shapes and sizes that have handles.

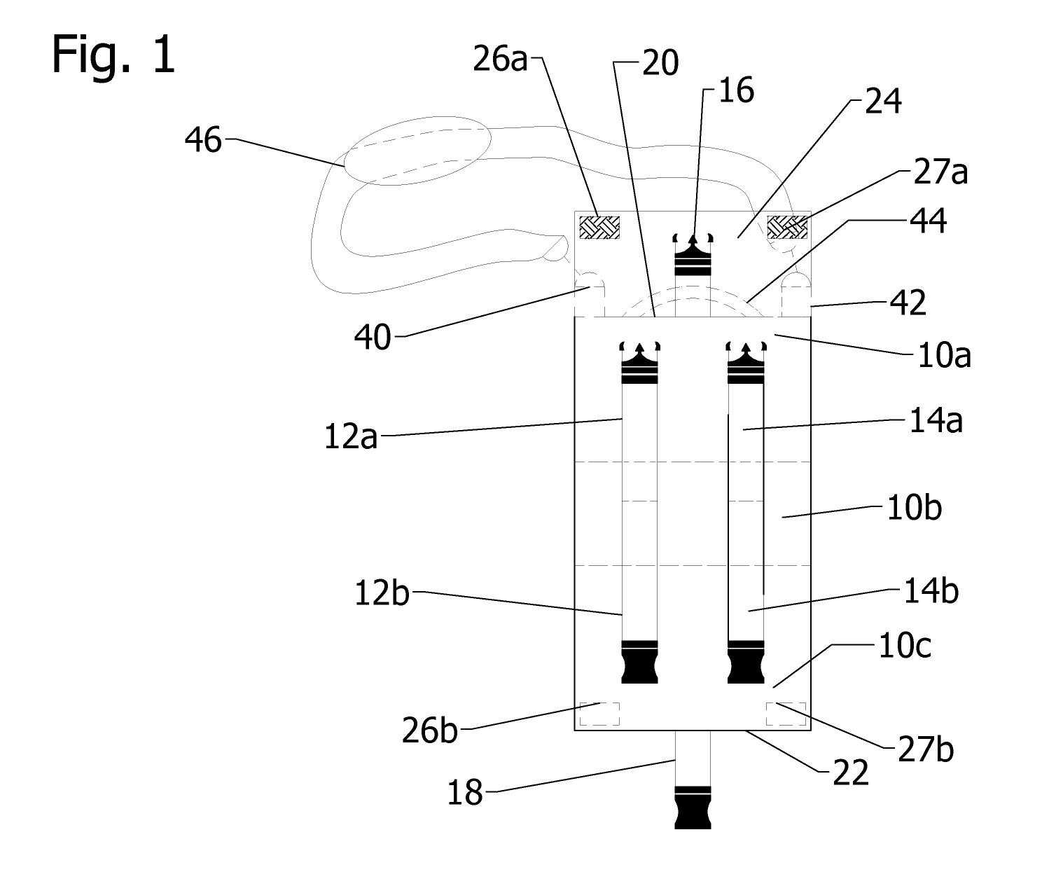

Referring to FIG. 1, the inside of the adjustable carrier for musical instrument cases, utilizing a method for securing cases which have handles, is shown. The fabric (10a, 10b, 10c) is laid flat. The longitudinal straps (12a, 12b and 14a, 14b) are attached to the inside. A case with a handle would be placed in the center of the carrier (10b), and the longitudinal straps 12a and 14a would be threaded through the handle of said case. Straps 12a and 14a would then be connected to straps 12b and 14b, respectively. In these drawings, the straps are being connected with releasable buckles. Once the straps are connected, the fabric (10a, 10c) would be folded around the case. Strap 16, (attached to rigid edge 20), would be connected to strap 18 (which is attached to rigid edge 22). In this drawing, the straps are being connected with releasable buckles. Then flap 24 would be folded over the top, over rigid edge 22, and would be connected to the outside fabric. In this drawing, hook and loop fabric (26a and 27a) is used to secure the flap to the corresponding hook and loop fabric (26b and 27b), located on the outside of the carrier and shown as hidden in this drawing.

FIG. 1 also shows the removable shoulder strap 46, which connects to D-rings 40 and 42, which are shown as hidden behind flap 24.

FIG. 1 also shows that handle 44, which can be used to pick up or hang the adjustable carrier for musical instrument cases, utilizing a method for securing cases which have handles, is hidden behind flap 24.

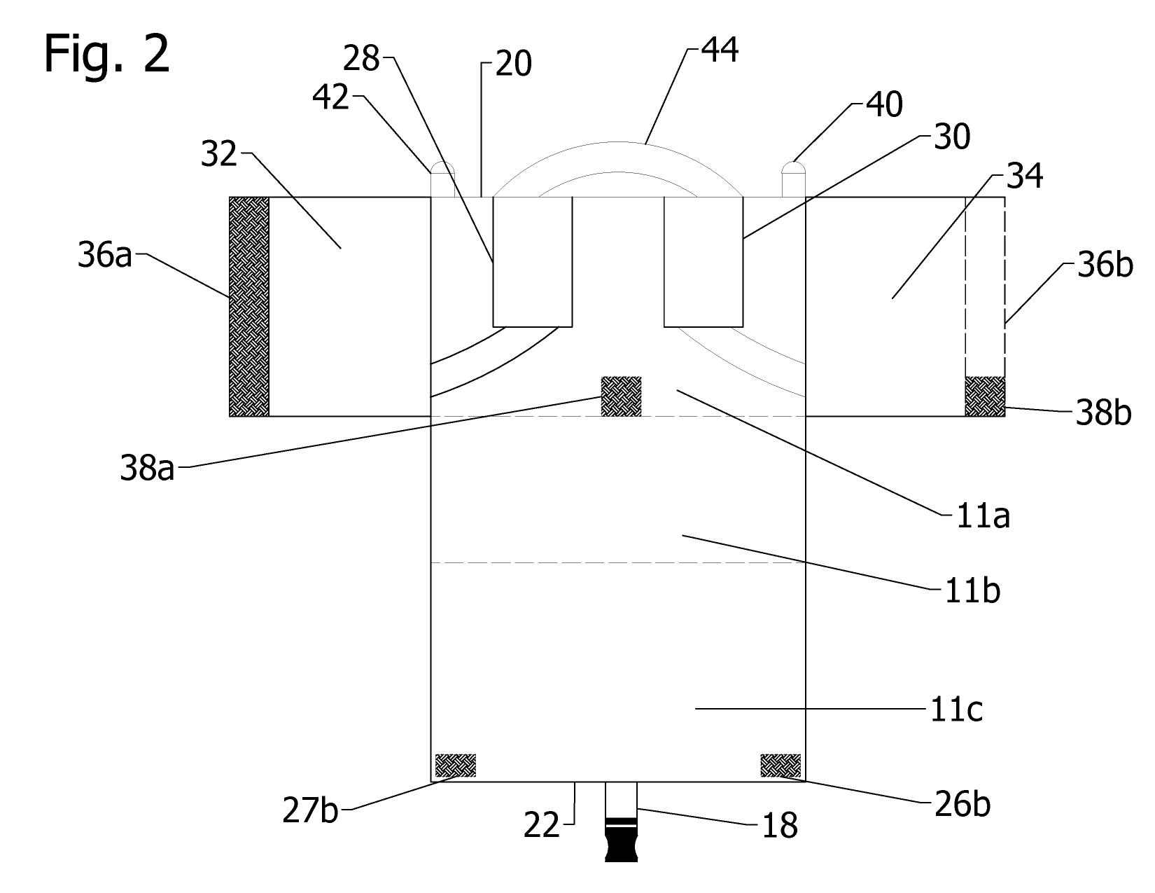

Referring to FIG. 2, the outside of the adjustable carrier for musical instrument cases, utilizing a method for securing cases which have handles, is shown. In this view, we see the back side of the fabric (11a, 11b, 11c). The handle 44 is also visible. Backpack-style straps 28 and 30 are attached to the fabric (11a). Flaps 32 and 34 are shown open. When closed, they cover backpack-style straps 28 and 30 and attach to one another and fabric 11a. In this drawing, hook and loop fabric [36a, 36b (hidden), 38a, 38b] is used. Also visible is strap 18 and hook and loop fabric (27b, 26b). D-rings 42 and 40 are attached to rigid edge 20.

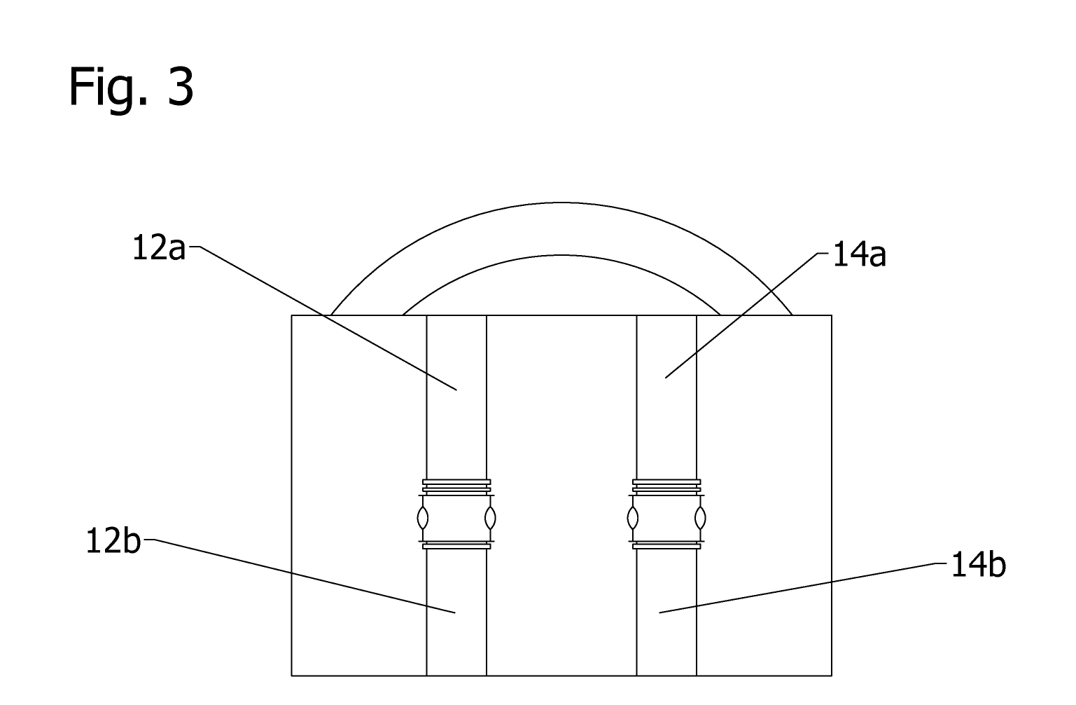

Referring to FIG. 3, a case with a handle is placed on straps 12a, 12b, 14a and 14b. FIG. 3 shows straps 12a and 14a threaded through the handle of the case and connected to straps 12b and 14b, respectively. In this drawing, the straps are connected with releasable buckles.

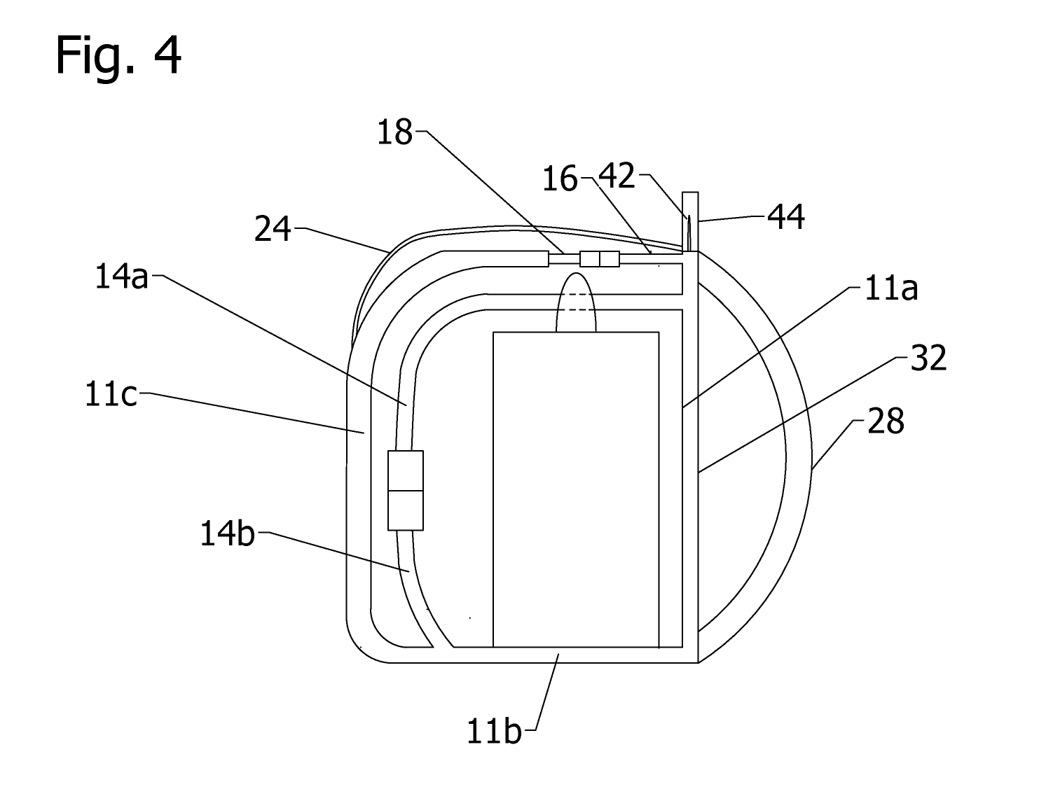

Referring to FIG. 4, we see an upright side view of the adjustable carrier for musical instrument cases, utilizing a method for securing cases which have handles, ready to be carried with the backpack-style straps. A case with a handle is shown secured to the carrier. Backpack-style strap 28 is visible and ready to be placed over the operator's right shoulder. Strap 14a and 14b is seen threaded through the handle of the case and connected. (Strap 12a and 12b is also connected but not visible.) In this drawing, the strap is connected with releasable buckles. Fabric 11b forms the bottom of the carrier. Fabric 11a and 11c are folded around the case and secured, with strap 16 connected to strap 18. In this drawing, the straps are connected with releasable buckles. Flap 24 is folded over the top and connected to fabric 11c. Handle 44 is visible at the top of the carrier. D-ring 42 is also visible. Flap 32 is tucked under back-pack-style strap 28 and is in the closed position.

Operation:

The fabric (10a, 10b, 10c) is laid flat. A case with a handle would be placed upright on the carrier, in the center (10b). The longitudinal straps 12a and 14a would be threaded through the handle of said case. Straps 12a and 14a would then be adjusted for length and connected to straps 12b and 14b, respectively. Once the straps are connected, the fabric (10a, 10c, 11a, 11c) would be folded around the case. Strap 16 would be connected to strap 18. Flap 24 would then be folded over the top of the carrier and connected to the outside fabric (11c) using hook and loop fabric or other fastener.

The carrier can then be transported by either using the backpack-style straps (28 and 30) or the removable shoulder strap 46. Backpack-style strap 28 would go over the operator's right shoulder, and backpack-style strap 30 would go over the operator's left shoulder. If the backpack-style straps are used, the removable strap 46 can be removed from d-rings 40 and 42. Flaps 32 and 34 would be tucked under the backpack-style straps and secured with hook and loop fabric or other fastener. If the removable shoulder strap 46 is used, the backpack-style straps can be covered with flaps 32 and 34, which would be secured to each other and the outside fabric 11c with hook and loop fabric or other fastener.

Conclusion, Ramifications, and Scope:

Thus, the reader can see that at least one embodiment of the adjustable carrier for musical instrument cases, utilizing a method for securing cases which have handles provides an effective solution to a musician looking for an easier method to transport an instrument.

While the above description contains many specificities, these should not be construed as limitations on the scope, but rather as an exemplification of one embodiment, thereof. Many other variations are possible. For example, straps 12a, 12b, 14a, 14b, 16, and 18 could be secured by alternate methods, such as a hook and loop fabric, snaps, or other methods.

The fabric 10a, 10b, 10c, 11a, 11b, and 11c can be made out of a variety of materials. Its shape can also be modified. Pockets can be added to the fabric (10a, 10c, and 11c). For example, in one embodiment of the invention, on the inside of the carrier, the fabric 10a also includes an accordion-style pocket, with two or more pockets on fabric 10c.

The backpack-style straps can be modified to effectively carry the load. They may include a chest strap. There may also be a strap that clips around the waist of the operator.

The removable shoulder strap 46 may be padded. It also may include removable padding. It may be attached to the D-rings (40 and 42) using a variety of methods.

Additional D-rings may be added to the fabric. Other items such as keys and accessory pouches can be clipped to the D-rings.

Furthermore, this carrier is not limited to use for cases containing musical instruments.

Thus, the scope of the embodiments should be determined by the appended claims and their legal equivalents, rather than by the examples given.

We claim:

1. A detachable carrier for transporting a musical instrument case or other case with a handle, comprising:
a. padded rectangular fabric with a top and bottom rigid edge, two side edges, an inside surface, an outside surface, at least three sections of padded fabric, and at least one connector at each rigid edge
b. a flap attached to the top rigid edge, which connects to the outside surface near the bottom rigid edge
c. a system to hold said case
d. 2 backpack-style straps
e. a removable shoulder strap.

2. The system of claim 1, wherein two longitudinal straps, attached to the inside surface, are wrapped around said case, threaded through the case's handle, and connected.
